(19) United States
(12) Patent Application Publication
(10) Pub. No.: US 2016/0253770 A1
(43) Pub. Date: Sep. 1, 2016

(54) SYSTEMS AND METHODS FOR GENETIC TESTING ALGORITHMS

(71) Applicant: YouGene Corp., New York, NY (US)

(72) Inventors: Ryan Downs, Alexandria, VA (US); Roger C. Hahn, Fairfax, VA (US)

(73) Assignee: YouGene Corp, New York, NY (US)

(21) Appl. No.: 15/149,539

(22) Filed: May 9, 2016

Related U.S. Application Data
(63) Continuation-in-part of application No. 13/371,422, filed on Feb. 11, 2012.
Application No. 13/371,422 is a continuation-in-part of application No. 14/483,921, filed on Sep. 11, 2014.
Application No. 14/483,921 is a continuation-in-part of application No. 14/452,979, filed on Aug. 6, 2014.

(51) Int. Cl. G06Q 50/18; G06F 19/00; G06F 19/22

(52) U.S. Cl. CPC G06Q 50/184; G06F 19/22; G06F 19/366; G06F 19/322; G06F 19/3443

(57) ABSTRACT

Disclosed are systems and methods for creating an in silico biomarker test. The systems and methods allow for receiving genetic or other biomarker information, along with patient metadata, and utilizing this information in order to create the new tests. The systems and methods may additionally include the ability to create genetic tests from raw genetic data received by the system. The systems and methods may utilize machine learning processes to determine the effect of one or more biomarkers on a phenotypic result for a patient based on one or more features determined to effect phenotypic results.

### CROSS-REFERENCE

The present invention is a continuation-in-part of U.S. patent application Ser. No. 13/371,422, filed Feb. 11, 2012, U.S. patent application Ser. No. 14/452,979, filed Aug. 6, 2014, U.S. patent application Ser. No. 14/483,921, filed Sep. 11, 2014, and U.S. patent application Ser. No. 14/511,293, filed Oct. 10, 2014, the entire contents of which are incorporated herein by reference.

### FIELD OF THE INVENTION

This disclosure relates to methods and systems for developing novel algorithms and methods for genetic testing, and facilitating the use of proprietary biomarkers across users and payment for the use of intellectual property rights between users of the systems and methods. The methods and systems of the invention further provide genetic data that can be securely searched and interpreted to generate results of genetic tests without the need to send large genome files over the internet.

### BACKGROUND

Thousands of genetic features of unknown significance exist within the human genome. These features can cause genetic disease, influence the effectiveness of medical treatments, or provide other phenotypic attributes to a patient. Hence, there is a need for a system that is capable of identifying these genetic features, and accurately determining the effect of these features on phenotypic results.

The proliferation of studies employing genetic information has led to the increasing use of genetic information for diagnostic purposes. Physicians often gather information from a patient to access risk for various conditions such that further diagnostic tests, follow-up visits and prophylactic measures can be employed in an efficient manner. For example, a physician utilizing their professional judgment may decide that a patient having a family history of breast cancer warrants more frequent mammogram screening. Similarly, a patient having certain combinations of physiological and demographic parameters, such as sex, age, weight and height, and blood test results, may require preventive measures to forestall the development of heart disease, diabetes or other lifestyle diseases.

Recent advances allow for genetic profiles of individual patients to be developed without prohibitive costs. In addition to genetic information, metabolic, proteomic, and lipidomic data are increasing available for profiling individual patients in a clinical setting. Genetic, metabolic, proteomic, lipidomic and metabolic data can serve as biomarkers amenable to profiling risk for various diseases or conditions. For example, mutations in the BRAC1 and BRAC2 genes are used in clinical settings as biomarkers for indication of risk for developing breast and ovarian cancer. Alternatively, an analysis of the protein isolectric point values and quantity of specific proteins can indicate an on-going disease process before other symptoms are readily apparent.

Diagnostic tests employing the use of biomarkers are frequently protected by intellectual property rights usually in the form of issued patent claims. Often times, identifying the presence of particular biomarkers does not necessarily require the acquisition of materials or equipment from the owner of the intellectual property associated with the biomarkers. By means of example, the presence or absence of specific genomic mutations can be performed through the use of multipurpose sequencing equipment or genechips. Further, the number of laboratories and clinical settings having access to equipment for determining genetic information and other biomarkers is becoming increasing widespread as cost barriers are decreased. As such, the benefit of diagnostic intellectual property rights can be accessed through the use of increasingly standardized equipment without the need for acquiring any materials from the rights holder of the intellectual property in question.

Licensing for the use of intellectual property traditionally results from direct negotiation between the rights holder and one or more users or licensees. However, transaction costs become prohibitive when many potential users or licensees are present on the landscape. This is particularly true when potential users or licensees occasionally perform diagnostic tests associated with particular intellectual property rights. In addition, a diagnostic service may perform a test resulting in a wide range of information such as whole genome shotgun sequencing (WGS) or a genome-wide SNP analysis using a genechip, where a wide range of potential proprietary markers useful for diagnostic purposes can be revealed. However, the individual or organization performing the diagnostic service is unaware how the generated information may be used by other parties or what intellectual property rights may be implicated. A further complication is that certain diagnostic tests may require the evaluation of biomarkers that may be covered by multiple patents belonging to multiple different rights holders. The acquisition of a comprehensive profile of biomarkers associated with a specific condition may implicate patents owned by several different entities thereby creating large transactional costs in directly licensing the relevant intellectual property.

The need to negotiate and manage a large number of licensing agreements is a disincentive for potential users or licensees to respect the intellectual property rights of patent rights holders. Alternatively, the need to manage a large number of licensing agreements can discourage the use, development and/or validation of biomarker-based diagnostic techniques, particularly in situations where it is difficult to determine all the rights holders that may be implicated. This challenge has been recognized as creating “patent thickets,” where commercial activity or legal compliance in an area is discouraged by a “thicket” of patent rights controlled by several different entities.

### SUMMARY OF THE INVENTION

A system and methods are provided for determining genetic features that may influence specific phenotypic results, such as genetic diseases or the effectiveness of particular medical treatments.

The system is also provided for facilitating the use of proprietary biomarkers in genetic testing, and analyzing and reporting the results of genetic tests. The system can comprise a control server connected to a remote application, the remote application configured to obtain results of a genetic test. The control server can also be connected to a proprietary records database containing records of proprietary biomarkers and rights holders of the proprietary biomarker. A genetic data storage server containing genetic information for one or more patients can be in communication with the remote application. The remote application can be configured to send and receive data for conducting the genetic test. The control server can be configured to send and receive data for accounting for payment from a payer party to the rights holder. The control server can also be configured to account for payments from a payer party to the owner of the genetic data storage server.

A method for obtaining a genetic test and accounting for payments to rights holders is provided. The method can comprise obtaining genetic usage information from a payer party. The method can comprise proprietary records database, the proprietary records database containing records of proprietary biomarkers and the rights holders of proprietary biomarkers. The biomarkers required for a genetic test can be determined, and payment to the rights holders can be accounted for. The genetic testing can be carried out by a remote application, or can be carried out by a third party scan application.

The genetic usage information can comprise a prescription for a genetic test, the biomarkers to be searched during a genetic test, and/or the portions of the genome to be scanned during a genetic test.

Licenses for the use of proprietary biomarkers can be obtained before or after a request for a genetic test is created. These applications can be transferred to the scanning party in order to carry out the test. The system and methods can account for the payment of royalties or licensing fees associated with the biomarkers.

The system can also determine tests for new biomarkers based on the results obtained from tests including known biomarkers. Patients being tested for a particular disease can be separated into subgroups, and the genetic information of the patients in each subgroup searched to determine a correlation at various genetic locations to the disease.

### BRIEF DESCRIPTION OF THE DRAWINGS

FIG. 1 shows an overview of a system for determining genetic features from patient genetic data.

FIG. 2a shows a generic supervised dimensionality reduction matrix.

FIG. 2b shows an example supervised dimensionality reduction matrix for seven genetic samples and five features.

FIG. 3a shows a generic test attribute matrix.

FIG. 3b shows an example test attribute matrix including seven genetic samples.

FIG. 4 shows a generic process of determining a novel algorithm to predict a phenotypic result based on genetic data.

FIG. 5 shows a process of determining a novel algorithm to predict a phenotypic result in a system using seven genetic samples and five genetic features.

FIG. 6 shows an overview of a system for determining the accuracy of a new genetic test.

FIG. 7 shows a generic process of determining the accuracy of the new genetic test.

FIG. 8 shows a process of converting raw genetic data into a genetic test.

FIG. 9 shows a schematic for a system for facilitating the use of proprietary biomarkers across users and facilitating payment for the use of intellectual property rights between users of the system.

FIG. 10 shows the functionality of user interfaces of the system.

FIG. 11 shows a flow chart for querying the system for the presence of proprietary biomarkers in a patient record.

FIG. 12 shows an exemplary relational database structure for a system for facilitating the use of proprietary biomarkers across users and facilitating payment for the use of intellectual property rights between users of the system.

FIG. 13 shows an exemplary hardware implementation for implementing the methods described herein.

FIG. 14 shows an exemplary large-scale hardware implementation for implementing the methods described herein.

### DETAILED DESCRIPTION

### Definitions

Unless defined otherwise, all technical and scientific terms used herein generally have the same meaning as commonly understood by one of ordinary skill in the relevant art.

The articles “a” and “an” are used herein to refer to one or to more than one (i.e., to at least one) of the grammatical object of the article. By way of example, “an element” means one element or more than one element.

The term “administrator” or “administrator user” refers to one or more individuals or parties responsible for maintaining the soundness and usability of the systems and methods described herein.

The term “authority” refers to having the right to access certain information stored in a system or database.

The term “biomarker” refers to a substance that whose quantitative or qualitative characteristics are used to determine a biological state or the presence or risk for a disease or condition. Biomarkers expressly include genomic information as indicated by a sequence or presence of certain nucleotide bases in a DNA molecule. Other express and non-limiting examples of biomarkers include quantitative or qualitative information regarding single nucleotide polymorphisms (SNPs), whole genome sequencing, genetic mutations, genetic linkage disequilibrium, metabolite information, proteomic information and lipidomic information.

The term “collocated” refers to two or more servers, databases, computers, software applications, or any other computing module being in the same location. The same location can mean on the same server, virtual instance, or computer, on a single intranet, or located in the cloud behind the same firewall. “Collocated” can also refer to two or more modules configured such that data can be transmitted between the two or more modules without transmitting the data over the internet. “Collocated” can also refer to two or more modules configured such that one of the modules is embedded within the other module.

The term “comprising” includes, but is not limited to, whatever follows the word “comprising.” Thus, use of the term indicates that the listed elements are required or mandatory but that other elements are optional and may or may not be present.

The term “consisting of” includes and is limited to whatever follows the phrase “consisting of.” Thus, the phrase indicates that the limited elements are required or mandatory and that no other elements may be present.

The phrase “consisting essentially of” includes any elements listed after the phrase and is limited to other elements that do not interfere with or contribute to the activity or action specified in the disclosure for the listed elements. Thus, the phrase indicates that the listed elements are required or mandatory but that other elements are optional and may or may not be present, depending upon whether or not they affect the activity or action of the listed elements.

The term “control server,” “control application,” or “CS” refers to a server or application configured to communicate with other servers, databases, or applications and to send and receive information from the other servers, databases or applications.

The term “database” refers to any organization of data or information that can be queried.

A “genetic data interpretations server” or “GDIS” is a server or database containing instructions on interpreting genetic or other biological data.

A “genetic data storage server” or “GDSS” is a server or database containing genetic or other biological data pertaining to one or more patients.

“Genetic usage information” refers to the information necessary for conducting a genetic test. As use herein, genetic usage information can refer to a prescription for a genetic test, the biomarkers to be searched during a genetic test, and/or the portions of the genome to be scanned during a genetic test.

The term “field” refers to a category of information entered into a database, where the field contains the same quality or type of data between records.

The term “information” refers to any algorithm, script, association, or any other data that can be stored by a computer.

The term “phenotypic information” refers to any manifestation of a particular genotype.

A “prescription for a test” is a request by any party to search or analyze biological information.

The term “record” refers to a set of data present in a database that is associated with the same object such as a patient or biomarker.

A “remote client,” “remote client application,” or “RCA” is an application collocated with a genetic data storage server, and configured to receive instructions for interpreting genetic data and to interpret the genetic data according to the instructions.

A “third party request application” is an application collocated with a genetic data storage server and remote client that allows a request for a test to be made directly to the remote client.

The terms “diagnostic service provider, “diagnostic service user” and “diagnostic service provider user” refer to a party or organization that performs tests or other laboratory work to generate information concerning the presence of biomarkers in a patient.

The term “diagnostic information” or “raw diagnostic information” refers to information generated from a laboratory or other test that contains biomarker information, where information regarding a biomarker need not be tagged, highlighted or identified within the diagnostic information.

The term “physiological parameter,” “physiological data” or “physiological information” refers to here to refer to measurements of physiological functions that are not necessarily limited to the quantitative or qualitative of chemical substances and biomarkers. Non-limiting examples include sex, age, height, weight, blood pressure, heart atrial or ventricle pressure, heart rate, pulse, blood chemistry, glomerular filtration rate (GFR), EKG data, PET data, MRI data, and other data indicating the homeostasis or condition of the body.

The term “demographic parameter,” demographic data” or “demographic information” refers to information that can be used to predict or determine the health status or risk for a disease or condition for an individual that does not necessarily require the physical examination of the individual. Non-limiting examples include medical history of the individual or relatives of the individual, life-style habits such as diet, exercise, smoking alcohol consumption patterns or sexual activity, prior medical procedures or medical appliances such as a pacemaker or a stent, exposure to environmental health risks, etc.

The term “clinical parameter,” “clinical data” or “clinical information” refers to either physiological parameters or demographic parameters.

The term “payment” refers to the creation of a record detailing the obligation of one user of the systems or methods described herein to pay another user of the systems or methods described here. The actual receipt of financial funds is not necessary to complete a “payment.” Rather, the financial funds can be escrowed by an administrator or another party who receives funds from one user and holds them for benefit of another user. Alternatively, payment can be completed by updating a log, database, or sending a notification that payment is due from one party to another where the transfer of financial funds can occur at some later time. However, a “payment” can also occur by the transfer of financial funds from one user to another user.

The term “privacy rules” refers to a set of rules implemented to control the level of access or authority for information stored on a system or database.

The term “proprietary biomarker” refers to a biomarker associated with certain intellectual property rights, where such intellectual property rights can include patent claims providing for specific methods for using, detecting or deriving information from the biomarker as well as compositions of matter for detecting the biomarker. In any embodiment the proprietary rights can include patents, trade secrets, copyrighted code or any other rights in the proprietary biomarker or use of the proprietary biomarker.

The terms “restricting,” “restricting information,” and similar terms refer to limiting the access to information stored on the system described herein or accessible using the methods described herein to specific users.

The terms “rights holder” or “rights holder user” refers to a user or party that is the owner of intellectual property rights for which the systems and methods described herein are providing payment for the use of subject matter within the domain of those intellectual property rights by other users or parties. Intellectual property rights specifically include patent claims but can also include other recognized intellectual property rights.

The term “payer party” or “payer party user” refers to an insurer or other party that is responsible for at least a partial payment to another user of the system and methods described herein. The payer party in addition to an insurance company can include a patient receiving the benefit of a diagnostic service.

The term “patient” or “patient user” refers to an individual, human or animal, from whom diagnostic information concerning biomarkers is taken.

The term “physician” or “physician user” refers to an individual, regardless of any licenses issued by a governmental authority, which uses the systems or methods described herein to identify or access biomarkers for purposes of making a medical evaluation using the systems or methods described herein.

The term “user” refers to any party or agent of a party who sends or receives information from the systems described herein or by means of the methods described herein.

The term “table” refers to an organization of data in a database.

The term “foreign key” refers to a parameter that serves as a restraint on data that can be entered on a database table.

The term “proteomic” refers to information relating to any of the quantity, identity, primary structure (sequence of amino acid residues), pI (isoelectric point), or any other qualitative information related to proteins present in a biological sample.

The term “lipidomic” refers to information relating to any of the quantity, identity, chemical structure, oxidation state or any other qualitative information related to lipids present in a biological sample.

The term “patient identification information” refers to any data that contributes to the personal identity of an individual.

The term “relational database” refers to a database that can be queried to match data by common characteristics found within the dataset.

The term “cloud” refers to any network or server that exists as a separate entity from the internet.

The term “diagnostic test” refers to any process performed on a biological sample that results in information, termed “diagnostic information,” about the sample. The “diagnostic information” can include, but is not limited to, genomic, proteomic, and lipidomic information regarding the biological sample and standard blood tests for determining blood chemistry.

The term “server” means any structure capable of storing digital information. As used herein, “server” can also refer to a database, application, intranet, virtual instance, or other digital structure.

### System for Development of Feature Selection Tests

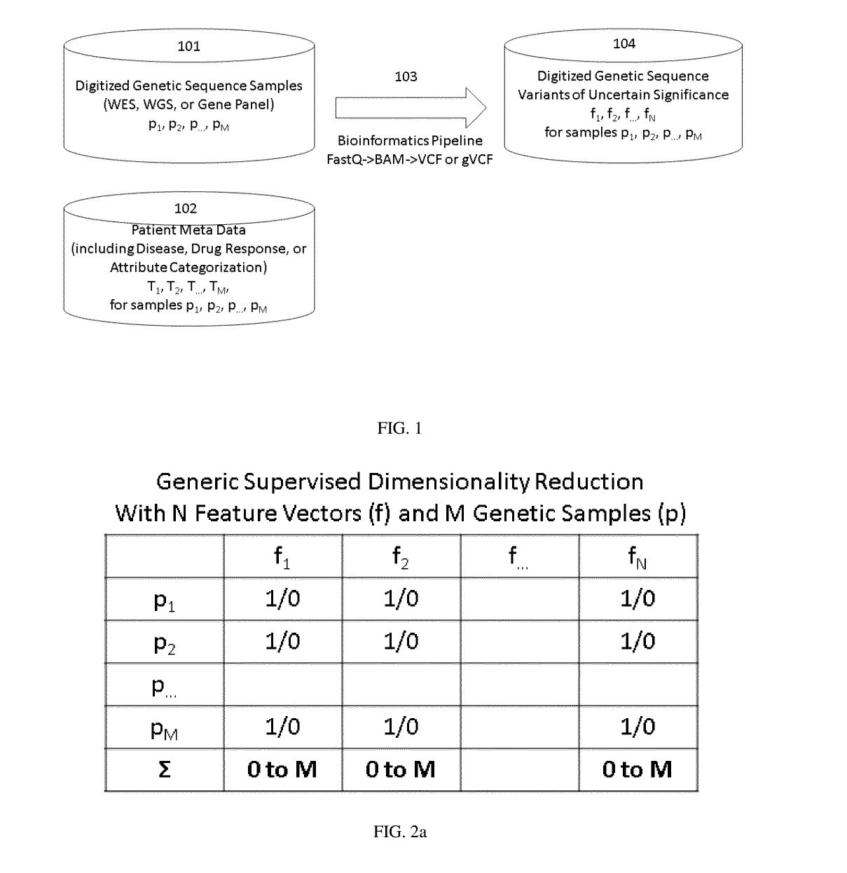

The systems and methods described herein provide for the development of new genetic tests based on patient data. FIG. 1 shows an overview of the system and methods. A genetic sample set 101 can be obtained by the system. In any embodiment, the genetic sample set 101 can comprise whole genome sequences, whole exome sequences, customized subsets of single or multiple genes, or other subsets of genetic sequences. The genetic sample set 101 comprises genetic samples for multiple patients, denoted as patient 1 through patient m (p₁ through p_{M}) in FIG. 1. The system can also receive patient metadata 102 related to the purpose of the genetic test. The patient metadata 102 for each patient can contain phenotypic information for each patient. In any embodiment the patient metadata 102 can contain each patient's disease state, as confirmed through alternative methods, each patient's response to a particular drug or class of drugs, or each patient's expression of some phenotypic attribute.

In any embodiment of the invention, the genetic data 101 received by the system can be in the form of raw genetic data, such as in a FastQ file. The raw genetic data can be entered into a bioinformatics pipeline 103, which can convert the raw genetic data into a form usable by the system. The genetic data can be converted by the bioinformatics pipelines 103 into binary genetic information form, such as in a BAM file. The resulting BAM file can be compared to reference genomes, which can identify attributes of each genetic sequence that deviate from the reference genomes. One of ordinary skill in the art will understand that these files are known as VCF or gVCF files. However, other file types or data storage methods are also envisioned to store attributes which do not align with a given reference genome. Although FIG. 1 shows the system receiving the genetic data as a FastQ file, a person of ordinary skill in the art will understand that the system can alternatively receive BAM or VCF files. In any embodiment, the system can receive already processed files, and step 103 can be omitted. One or more of the genetic attributes that deviate from the reference genomes are considered by the system to be genetic features. The system can create a set of genetic features 104, corresponding to each patient genome. The anomalies when compared to the reference genome for each patient can be made part of the feature set 104, where each identified feature is denoted as f₁ through f_{N}. The system can correlate each of the features with each of the patient sequences as explained herein.

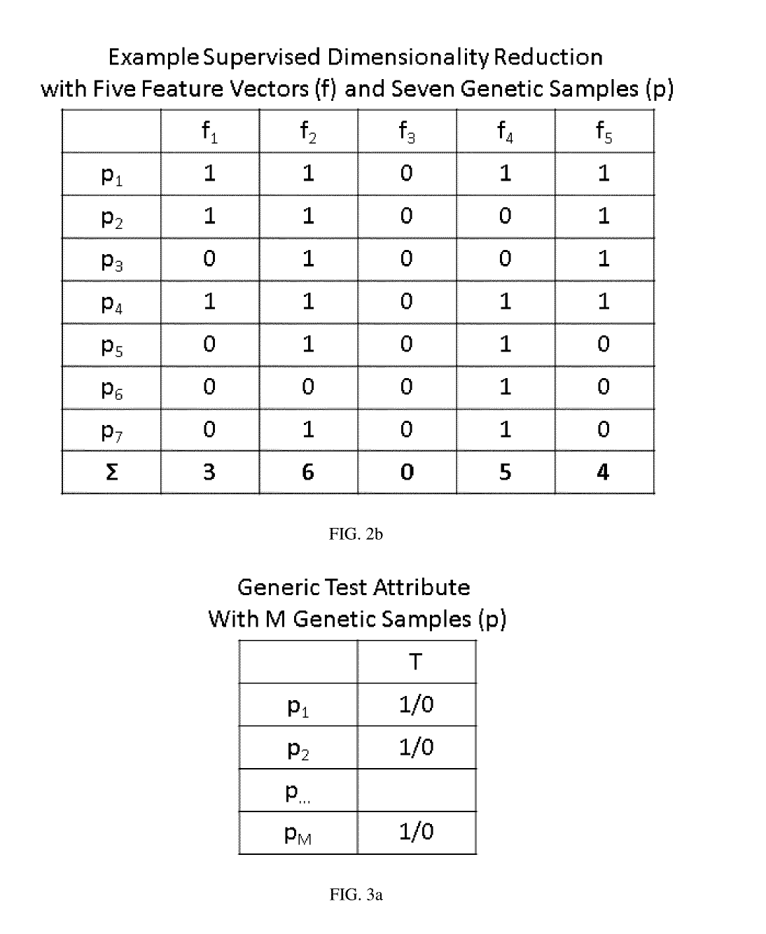

The process carried out by the system in identifying features and correlating these features to each genetic sample is explained in FIGS. 2a and 2b. FIG. 2a shows a generic representation of features in the feature set f₁ through f_{N}, and genetic samples for each patient p₁ through p_{M}. In each box, the system can determine whether the particular identified genetic feature is found in each patient sample. The system can use a binary method to denote the presence or absence of the feature in each patient sample, wherein a 1 can indicate that the feature is present, while a 0 can indicate that the feature is not present. The system can then tabulate the total number of samples having the particular feature as shown in the bottom row of FIG. 2a. The table shown in FIG. 2a is defined as a generic supervised dimensionality reduction with N features and M genetic samples.

FIG. 2b shows a notional Supervised Dimensionality Reduction with five features and seven genetic samples. The seven genetic samples are denoted as p₁ through p₇, while the features are denoted as f₁ through f₅. As shown in FIG. 2b, the system can determine whether each feature is present in each genetic sample, and tabulate a total indicating the number of samples provided with each feature. One of ordinary skill in the art will understand that the total number of features and total number of genetic samples used by the system can be significantly greater than the five features and seven genetic samples shown in FIG. 2b. The notional supervised dimensionality reduction shown in FIG. 2b is considerably smaller for the purposes of illustration.

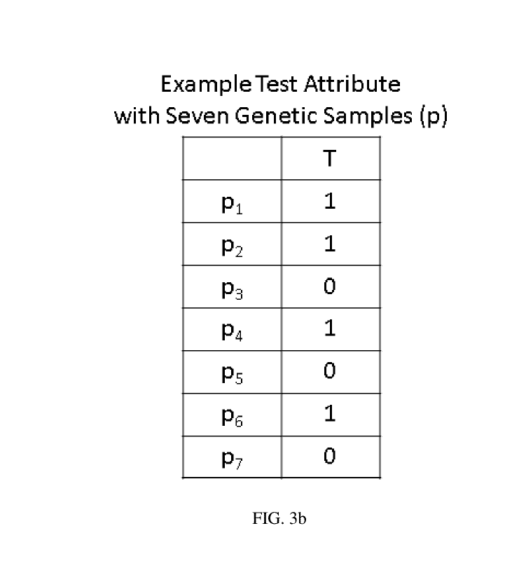

FIGS. 3a and 3b illustrate a test attribute matrix. FIG. 3a shows a generic test attribute matrix. The existence of some phenotypic result can be correlated with each patient p₁ through p_{M} in a binary fashion. For disease tests, the phenotypic result can be the existence of the disease in each patient as confirmed by any alternative method. For a drug effectiveness test the phenotypic result can contain each patient's response to a specific drug or class of drugs. FIG. 3b shows a notional test attribute matrix for one test outcome across seven patient genetic samples. A one shown in the test result column T can denote a positive test result, while a zero can denote a negative test result.

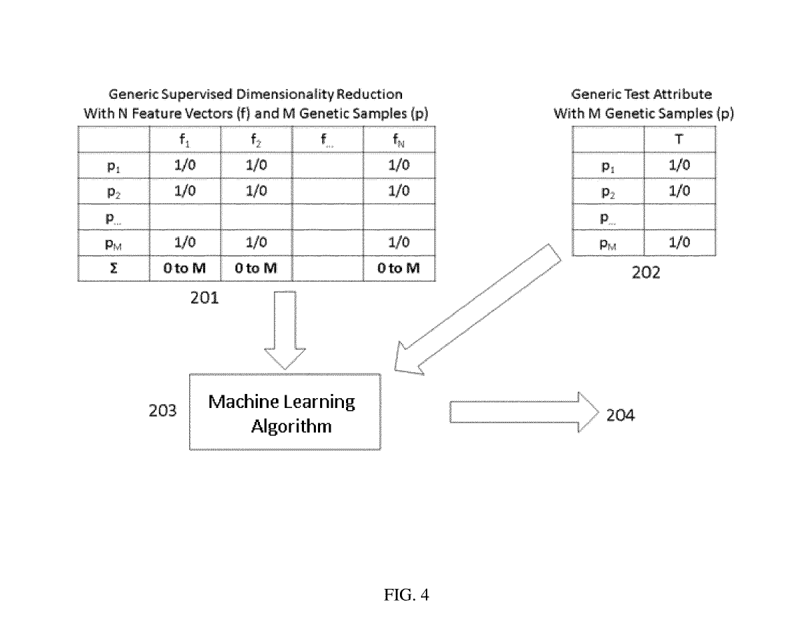

FIG. 4 illustrates a generic process of determining the effect of each feature on a phenotypic result. The supervised dimensionality reduction matrix 201 and the genetic test attribute matrix 202 as illustrated in FIGS. 2 and 3 are fed into a machine learning algorithm 203. A person of ordinary skill in the art will understand that there are many machine learning algorithms and techniques that can be used. One non-limiting example of a machine learning technique is a random forest technique; however, any machine learning technique is within the scope of the invention. As a result of the machine learning algorithm 203, the system can determine a novel method or novel algorithm to mathematically combine the values of the features in a feature set for a single patient genetic sample to predict the outcome of a test attribute as an output 204. In any embodiment, the result of the machine learning may be represented in any form known in the art, including a matrix of features, weights and discrete or fuzzy thresholds or flowcharts containing features, weight and discrete or fuzzy thresholds.

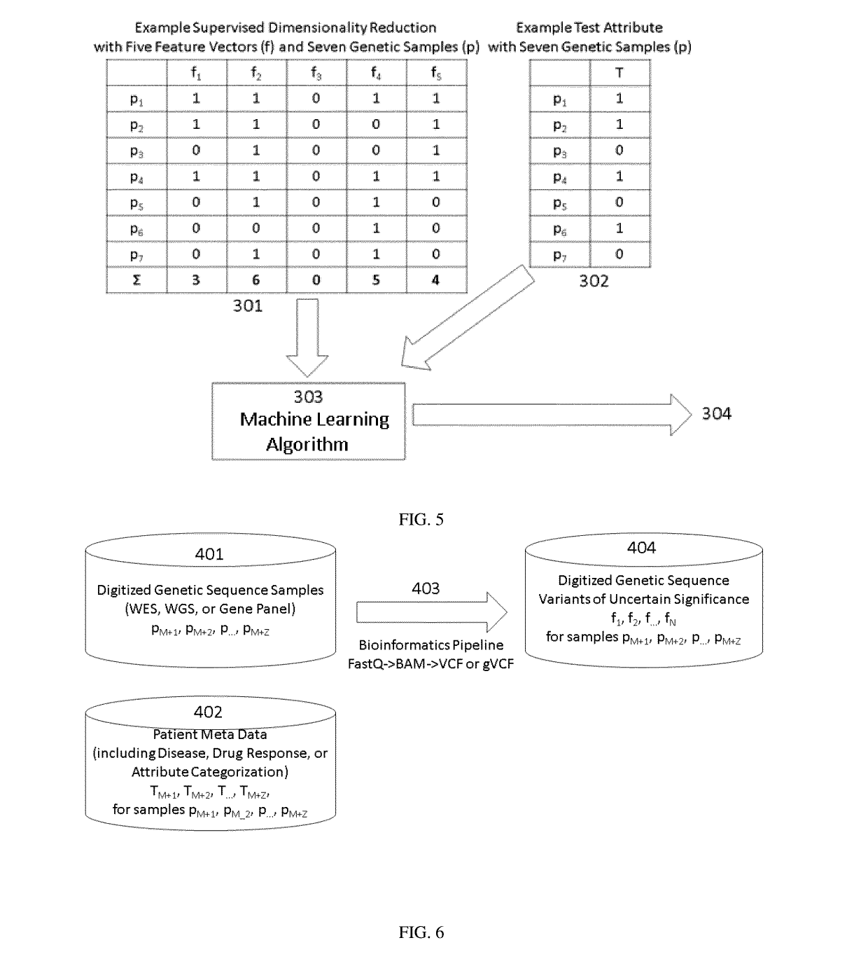

FIG. 5 shows a notional example of the process described in FIG. 4 for five features, seven genetic samples and a single test attribute. The supervised dimensionality reduction matrix 301 and the genetic test attribute matrix 302 as illustrated in FIGS. 2b and 3b for each of the seven patients and five features are fed into a machine learning algorithm 303. As in FIG. 4, the machine learning algorithm 303 can provide an output that mathematically combines the values of the features in the feature set to predict the outcome of a test attribute 304.

In order to confirm the accuracy of the novel genetic test illustrated with respect to FIGS. 1-5, the system can carry out a prospective study as shown in FIG. 6. Additional genetic sequence data can be obtained for a second set of patients 401, denoted in FIG. 6 as patients P_{M+1} to P_{M+z}. Metadata for these patients 402 can also be obtained, including the phenotypic information related to the genetic test for each patient, denoted as T_{M+1} to T_{M+Z}. The genetic sequence data 401 can be fed into the bioinformatics pipelines 403 as described with respect to FIG. 1. The digitized genetic sequences 404 including each feature for each patient can then be developed by the system as described herein.

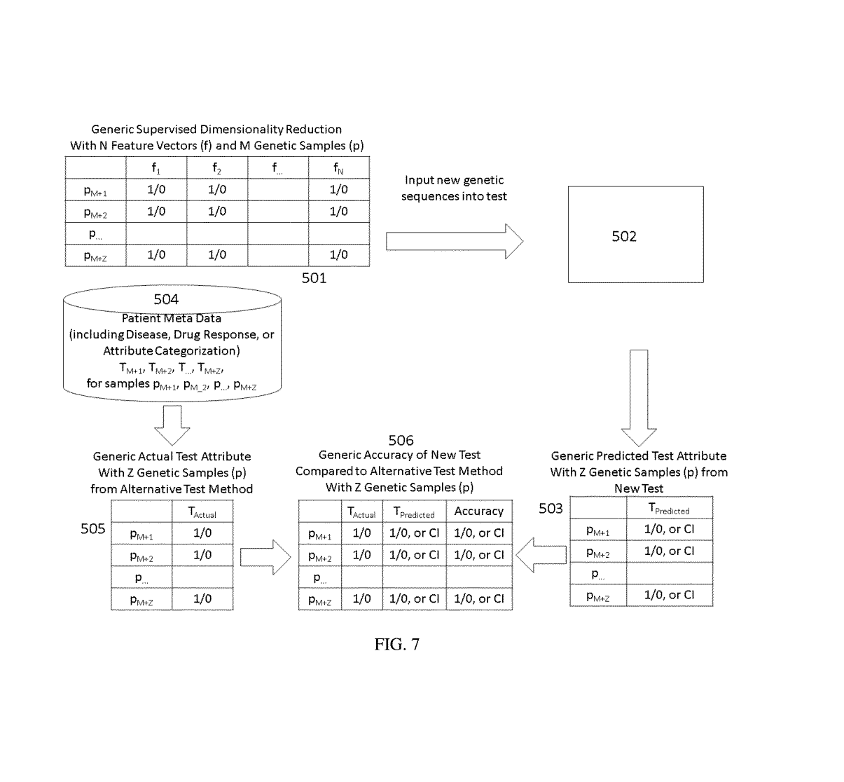

FIG. 7 illustrates a process of determining the accuracy of the new genetic test. A supervised dimensionality reduction can be created for the second set of patient samples 501, as explained herein for patients p_{M+1} through p_{M+z}. Each row in the supervised dimensionality reduction matrix can be processed through the novel genetic test or algorithm 502, created by the process illustrated in FIGS. 1-5. The genetic test can output a predicted test attribute for each patient, denoted as T_{predicted}, which can be stored in a predictive test result matrix 503. Patient metadata 504 can also be obtained by the system for the same patients, and an actual test attribute matrix 505 can also be created. The accuracy of the new genetic test can be obtained by comparing the predicted results to the actual results as shown in matrix 506. The value of the new method or novel algorithm is based on the ability to reliably and repeatedly determine the outcome based on the feature set.

In any embodiment of the invention, the number of patient samples in both the retrospective study described with respect to FIGS. 1-5, and the prospective study described with respect to FIGS. 6-7 can vary. One of skill in the art will understand that by increasing the number of samples used in each study, the accuracy and reliability of the novel algorithm or methods can be enhanced.

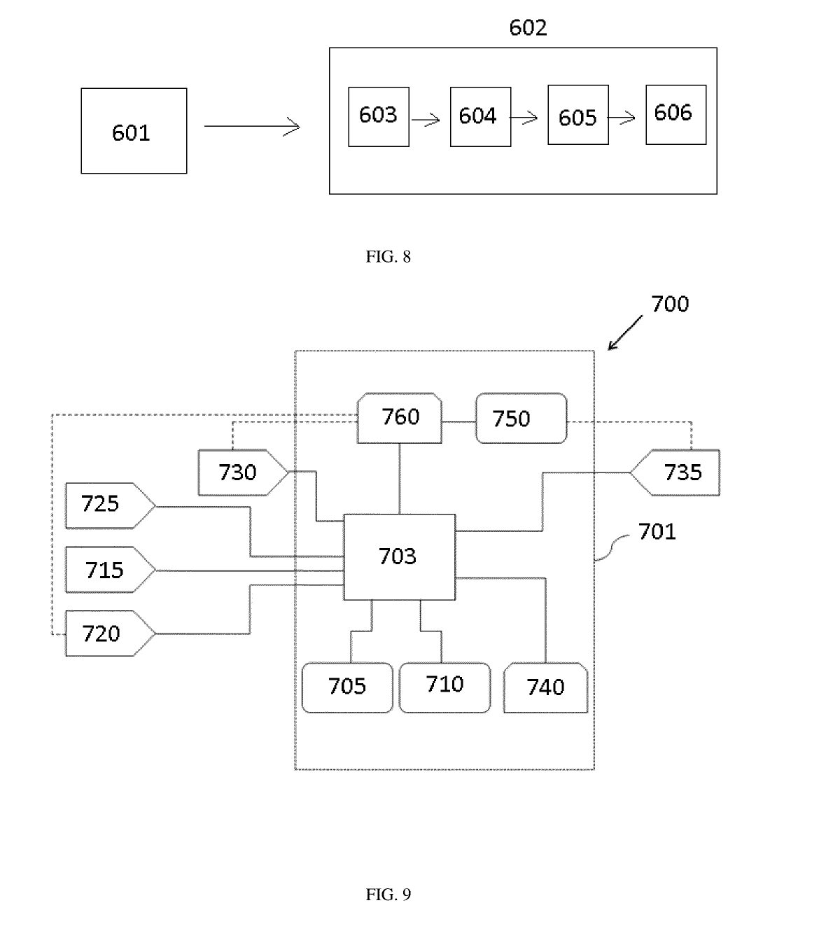

As explained herein, in any embodiment, the genetic data received by the system can be in the form of raw genetic data, such as in the form of a FastQ file. FIG. 8 illustrates the steps that can be utilized by the system to convert this raw data into VCF files that can be used as described herein. A patient genome can be sequenced in a primary analysis step 601 in a wet bench setting. The raw data obtained from the sequencing step 601 can then be transmitted to the system 602, which can be considered a dry bench setting. In step 603, the genetic information is obtained and the sequences aligned to create the binary genetic files. In step 604, the sequences can be compared to reference genomes in order to determine any deviation from the reference genome that can be used as the one or more features described herein. The system can annotate the patient genomes in step 605, and create the matrices that are described herein. In step 606 the system can conduct the methods described to identify novel algorithms or methods that are predictive of a particular phenotypic result.

The systems and methods described herein can also be used to determine the classification of new genetic variants as pathogenic or non-pathogenic. Genetic features that are determined by the system to be predictive of a pathogenic result can be directly classified as pathogenic or non-pathogenic. The variants can then be fed back dynamically and compared across other sources to check if the classification is correct. If the classification is determined to be correct, the system can be automatically updated to include the new variants in order to diagnose any future patients.

The ability to determine the accuracy of a new genetic test also allows for assistance with regulatory approval from government agencies, such as the FDA. New tests may need to be shown to accurately predict an outcome to obtain government approval. The system and methods described herein can provide the evidence that a genetic variant is predictive of a phenotypic result, allowing approval of a new genetic test.

### Use of Proprietary Genetic Test

The system described herein can also be used to conduct genetic testing on individuals. The novel methods or algorithms developed can be the subject of one or more proprietary rights. Further, any genetic testing carried out by the system can utilize additional genetic tests developed outside of the methods described in FIGS. 1-7. Any one or more these additional tests can be the subject of proprietary rights.

The systems and methods disclosed herein also provide for the linkage of patient- and/or specimen-centric molecular, genetic or other biomarker data to proprietary information useful for making medical diagnoses or risk assessments. The described systems can search multiple databases, indexes, catalogs or databases, and in various languages, for patented or proprietary genetic biomarkers and related information to populate and maintain the system database(s). Further, the novel methods and algorithms developed by the system can be held as proprietary information. Genetic biomarkers can include polymorphisms, linkage disequilibrium of alleles at multiple loci, and mutations in genomic or mitochondrial DNA. The systems can also receive input from a third party database or databases where the third party database can automatically upload new proprietary genetic information. The system database(s) therefore contain proprietary genetic information and/or biomarkers including owner information, clinical, diagnostic, and treatment data. The system database(s) can further contain error logs and/or audit logs to document data inconsistencies in the system database(s). Those skilled in the art will readily recognize that the data structure for maintaining the databases is not particularly limited and can, for example, employ a relational database management system or an object-oriented database management system.

The system also has a component for storing patient information in a system patient records database(s). In any embodiment, the patient records database(s) can be the same databases as illustrated in FIGS. 1-7, or can be separate databases utilized only for future testing. A physician user or another user can enter the patient's clinical data including medical history, attributes, physiological parameters, demographic parameters and/or laboratory test results in appropriate fields of a database. The system patient database(s) also contains information for genetic biomarkers or other biomarkers associated with specific patients. In some cases, a patient's biomarker information, such as, for example, Single Nucleotide Polymorphism (SNP) information, will be unknown at the time of examination or diagnosis by a physician. Therefore, in certain embodiments, the physician or another user can enter the patient's biomarker information into the system patient database(s) at a later time. In light of the increase in personalized medicine, patients are increasingly encouraged to actively engage in the collection and management of their personal health records. As such, in certain embodiments described herein, a patient-centric model for determining usage of proprietary biomarker information is employed where the determination of the need for payment to stakeholders can be triggered on the patient level rather than as a result of a licensing agreements or other relationships between the rights holders in particular biomarkers and particular diagnostic labs or physicians.

In other embodiments, diagnostic laboratories or physicians can perform required tests to determine patient biomarkers and directly upload the information into the system patient records database(s). The system can then correlate the patient's clinical and/or biomarker information with information in the system database(s), and/or access one or more public or private domain databases and generates a match for any proprietary biomarker information. In addition, a patient's clinical and/or demographic information can be compared with other patient records in the patient records database(s) to determine whether common attributes are present in the population identified by the system as sharing a common SNP or other biomarker for use in diagnosis and treatment. Information can then be communicated to the physician indicating that the individual shares attributes with a population of individuals having a common SNP or other biomarker. Accordingly, this method provides a means for identifying patients possessing genetic information and biomarkers that might read on proprietary uses and methods of utilizing the information. Further, notice to insurance companies or payer parties and payments to stakeholders of proprietary information can be made in an automated fashion.

With reference to FIG. 9, systems for implementation of the innovations disclosed herein will be described. In FIG. 9, a system 700 having a trusted server 701 (inside dashed rectangle) is provided to control access to one or more databases and manage the transfer of payment between users. Those skilled in the art will understand that trusted server 701 may be any configuration of one or more processors 703 (rectangles), data storage devices (rounded rectangles) and servers for communication capable of performing the functions disclosed herein. The system 700 can host various user interfaces (pentagons) and functional facilities (hexagons). The trusted server 701, and more particularly the one or more processors 703, controls access to information stored in a proprietary records database 710 and a patient records database 705 according to privacy rules that govern access to information contained in the proprietary records database 710 and the patient records database 705.

The patient records database 705 contains individual patient records that include patient identification information and diagnostic information, where each patient record is associated with a particular individual patient. The individual patient identification information can include such fields as first and last name, data of birth, physician information, address, social security or other identification number, or any other information that may potentially give an indication as to the identity of the patient associated with the identification information. Those skilled in the art will appreciate that the patient records database 705 is not limited to any particular device or hardware.

The proprietary records database 710 contains records of proprietary biomarkers, information regarding the rights holders of the biomarkers, and data or rules for the use of the biomarkers to diagnose specific diseases or conditions or indicate risk for specific diseases or conditions. In addition to biomarkers, the proprietary records 710 database can optionally contain demographic or clinical information that can be used to evaluate risk for specific diseases or conditions. Many biomarkers have increased predictive power when used in combination with certain demographic and/or physiological parameters. For example, the presence of a specific SNP may indicate an increased risk for certain diseases or conditions in combination with certain demographic and/or physiological parameters or information, such as age, sex, weight, height, blood pressure, EKG characteristics or certain prior medical history such as a vascular stent. Alternatively, the presence of specific SNP may indicate a particular therapeutic regimen such as administration of drug or use of a medical device. In particular, the presence of a SNP may indicate the implantation of an Implantable Cardio defibrillator Device (ICD). In some instances, the patent claims of a rights holder may only extend to the use of one or more biomarkers in combination with certain demographic and/or physiological parameters. In such instances, the intellectual property rights of a rights holder may only be implicated when a biomarker is present in a patient record in conjunction with certain demographic and/or physiological parameters.

A function of the system 700 is that access to the information in the patient records database 705 is restricted. Regarding information in the proprietary records database 710, the extent and owners of intellectual property rights, particularly patent rights, is usually publically known. As such, access to information in the proprietary records database 710 does not need to be restricted in certain embodiments. In particular, access to patient identification information is restricted to protect the privacy of the patients. In some embodiments, access to patient identification information is only granted by the privacy rules to a patient's physician and optionally a payer party having responsibility for a patient. Access to demographic and clinical information and biomarkers can be granted for the purposes of making comparisons between populations, as described above.

Medical information is oftentimes regarding as personal by many individuals, where disclosure of medical information that can be associated with a specific individual is often times regarded as a violation of trust or an intrusion into personal privacy under social norms. In addition to the social sensitivity of medical information, physicians and other medical providers can have ethical or legal obligations to shield the privacy of patient medical information. Still further, the presence of certain biomarkers, particularly genetic information, can be used to discriminate against specific patients. For example, knowledge of particular genetic information may be used by employers to discriminate in hiring or by health insurers to decline coverage. The potential illegality of such discrimination is not an absolute deterrent to its occurrence.

Medical information is entered into individual records in the patient records database 705 via a physician user interface 715 or a diagnostic service provider interface 720. As shown in FIG. 9, the physician user interface 715 is in communication with the trusted server 701. The physician user interface 715, in certain embodiments, is located on an internet web server where the physician user interface 715 can be accessed using a standard HTML web browsers. In other instances, the physician user interface 715 can be a specialized executable program running on a processor remote from the trusted server 701 or processor 703, where communication with the trusted server 701 is accomplished through the internet or other network.

The physician user interface 715 is accessible by a user having authentication credentials to identify the user as a physician user 715. A physician user 715 is a health care provider or an individual supervised by the health care provider who is authorized by a patient to enter or populate information associated with a specific patient record in the patient records database 705. A physician user 715 can have the ability to enter information into a patient record including patient identification information and demographic information either manually or in an automated fashion through electronic data provided by a separate electronic records system maintained by the physician user. Security rules can be set such that the physician user has access to the information contained in a patient record for which the physician has authority but not to identification information for patient records for which the physician does not have authority.

The authority of a physician user for a particular patient record in the patient records database can be established automatically upon the establishment of a new patient record. That is, the possession of identifying patient information used to establish the patient records presumes that the physician user has authority concerning that patient. Alternatively, the authority of a physician user can be verified or certified by a physician user already having access to the system, for example, where a patient switches medical providers. Alternatively, a patient user interface 725 can optionally be provided to allow the patient to designate the authority of a specific physician user. In certain embodiments, the patient user interface 725 does not have access to change the content of the patient records in the patient records database 705 to prevent an unsophisticated user from inadvertently changing the content of the patient record.

Optionally, the trusted server 701 can also be accessed through a diagnostic service provider interface user 720. Biomarkers are physical traits that are determined through laboratory testing often requiring sophisticated equipment. As such, a specialized testing laboratory or diagnostic service may be employed to directly perform diagnostic tests and generate diagnostic information. The diagnostic information can be reported to the physician whereupon the physician may update the diagnostic information contained in a patient record through the physician user interface 715. Alternatively, the diagnostic service provider user interface 720 may be provided to allow the testing laboratory or diagnostic service to directly update the diagnostic information of a patient record in the patient records database 705. The diagnostic service user interface may be accessible through an HTML viewer or a specialized executable program in a manner similar to the physician user interface 715.

The privacy rules operating on the trusted server 701 can be configured to allow a physician user a large degree of access to the patient records of the patient records database 705 for which the physician has authority, since a physician generally requires access to all of the patient identification information and diagnostic information contained in a patient record. In contrast, a diagnostic service provider typically does not need to have any significant access to patient information. As such, the privacy rules can be set to allow the diagnostic service provider to use the diagnostic service provider user interface 720 to upload diagnostic information to the patient records database 705. In certain embodiments, the diagnostic service provider need not be informed or have access to basic patient identification information such as name and date of birth. Rather, unique and/or one-time reference number for the particular diagnostic test can be provided to the diagnostic service provider while the trusted server 701 can correlate the reference number with a particular patient record to be updated.

Additional users of the system include a payer party user and a rights holder user, who access the trusted server 701 through a payer party interface 730 and rights holder interface 735, respectively. A function of the system 700 is to allow for the transfer of payment from a payer party to a rights holder when proprietary biomarker information is accessed through the physician user interface 715. The process for a physician to access proprietary biomarker information using the system 700 will be described in greater detail below.

Health care services, including diagnostic tests for biomarkers and physician treatment and advice based upon the presence of biomarkers, are often covered by health insurance where the patient receiving the services is not responsible for 100% of the necessary payment. The payer party user in some embodiments is a health insurer or other third party payer having responsibility for a specific patient represented by a patient record in the patient records database 705. Further, the patient themselves may also be responsible for all or part of the payment due for accessing certain proprietary biomarkers in the course of their care by a physician. As such, the payer party can further include a patient in addition to or in place of an insurer.

The privacy rules operating on the trusted server 701 can be configured to allow the payer party user access to only information necessary to verify the obligation to authorize a payment or review the validity of payments already sent. In some embodiments, the payer party user need not have access to the nature of the diagnostic query or test actually performed, rather only a guarantee that the service performed is of the type normally authorized by a specific health plan. As such, a patient record in the patient records database 705 can contain details of the identity of a payer party for that patient along with details of the extent of medical coverage provided by the payer party. A payer party user can choose to receive notification, as set in the privacy rules, that an insured patient has received an evaluation based upon proprietary biomarkers covered by insurance and choose to allow payments to processed without knowing the precise identity of the biomarkers concerned, although the payer party user can require the identity of the insured patient to verify coverage. As such, the system 700 can guarantee a high degree of patient privacy for sensitive medical information.

Typically, payer parties and insurers have access to the nature of medical diagnostic tests performed on insured persons, where such medical diagnostic tests are billed to the insurer. Here, a diagnostic service provider can still directly bill a payer party or insurer directly for their services performed as is the usual custom. For example, a diagnostic service provider can bill a payer party or insurer for the performance of a genome-wide SNP analysis using a genechip or similar test or a blood protein analysis; the nature of these diagnostic tests may be directly reportable to the payer party or insurer. However, as will be explained below in greater detail, the system 700 allows a physician user to access information concerning specific biomarkers measured by such tests. While a payer party user or insurer may have knowledge that a genome wide SNP analysis was performed on a specific insured patient, the payer party user's access to knowledge that a physician specifically evaluated biomarkers related to heart disease, cancer or other specific diseases or conditions can be shielded using the privacy rules of the system. Alternatively, payments to and from a diagnostic service provider user can be made through the system 700 as necessary to protect confidential patient information.

Similarly, a rights holder user typically does not require access to the identity of a patient or physician that has accessed information related to specific proprietary biomarkers. As such, the privacy rules can be configured to allow the rights holder user interface 735 to access information regarding the frequency of use of their proprietary biomarkers and verify the receipt of proper payment. However, the identification information of patients as well as the names of physicians and insurers can be shielded by the system 700 as required.

Those skilled in the art will readily understand that the privacy rules described above can be modified from the description above as required by certain users. For example, a payer party user can require a greater degree of information to authorize or review payments for the use of certain proprietary biomarkers, and the privacy rules can be modified to vary the degree of access to identification information and diagnostic information contained in the patient records database 705. The system 700 facilitates anonymous transfer of rights to use proprietary biomarkers and the anonymous transfer of payments to rights holders in such proprietary biomarkers. The invention specifically contemplates the use of any set of privacy rules that fulfill the aforementioned criteria.

The system 700 can include an optional notification server 740 that functions to send an email or other notification to any user containing the availability of new information from the system or a notice that new information is available upon accessing the appropriate interface. Such notification can be done using email or like notification or displayed by prompt upon a user logging into the system 700 after new information becomes available.

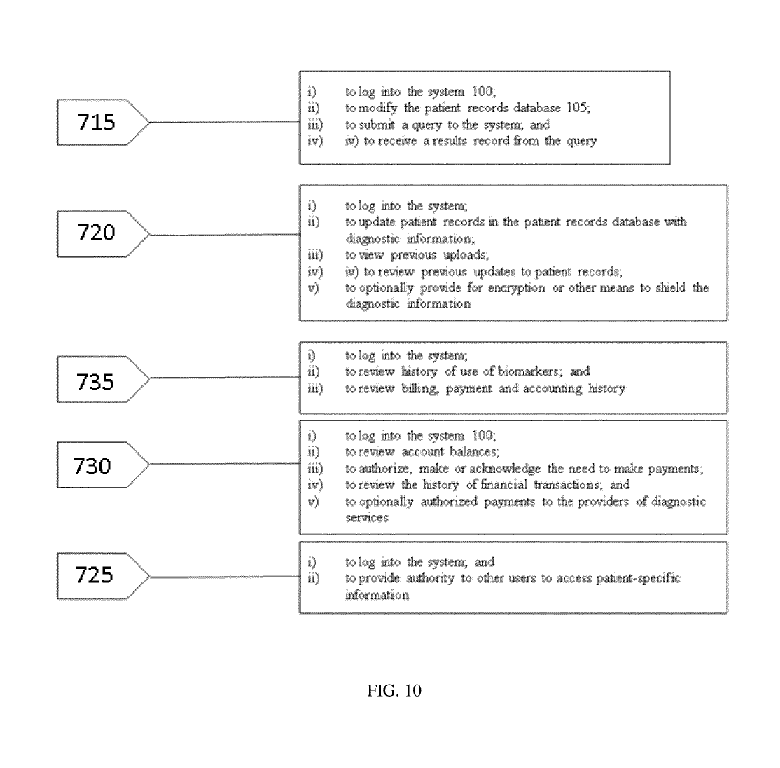

With reference to FIG. 10, the access to the patient records database 705 and privileges granted to different categories of users will be discussed. The physician user interface 715 provides the ability i) to log into the system 700; ii) to modify the patient records database 705 for authorized patient records including patient identification information and diagnostic information; iii) to submit a query to the system 700; and iv) to receive a results record from the query by email or by logging into the system 700. The diagnostic service provider interface 720 provides the ability i) to log into the system; ii) to update patient records in the patient records database 705 through use of a reference ID number and/or a doctor ID number with diagnostic information; iii) to view previous uploads; iv) to review previous updates to patient records and v) to optionally provide for encryption or other means to hide the diagnostic information from a technician performing the transfer of data to the system 700.

The rights holder user interface 735 provides the ability i) to log into the system; ii) to review history of use or matches of proprietary biomarkers associated with the rights holder user; and iii) to review billing, payment and accounting history for use or matches of proprietary biomarkers. The payer party user interface 730 provides the ability i) to log into the system 700; ii) to review account balances for insured patients; iii) to authorize, make or acknowledge the need to make payments to rights holder users; iv) to review the history of financial transactions; and v) to optionally authorized payments to the providers of diagnostic services. The patient user interface 725 provides the ability i) to log into the system; and ii) to provide authority to other users to access patient-specific information.

### Querying the System

As describe with regards to FIG. 9, the system 700 contains a trusted server 701 that functions to interact with users and implement privacy rules to control access to the patient records database 705. The physician user interface 715 and optionally the diagnostic service interface 720 are used to populate the patient records of the patient records database 705 with diagnostic information. The diagnostic information can contain a large quantity of data that requires analysis to determine the presence of proprietary biomarker information. For example, the diagnostic information can contain genome-wide genetic information that requires parsing to identify the presence of certain alleles, SNPs or mutations.

In certain embodiments, the diagnostic information is only accessed in regards to a specific query from a physician initiated through the physician user interface 715. As such, only biomarker information that is used by a physician to assess the risk for a specific disease or condition of concern is granted to the physician user, where such access results in the potential need for payment to a rights holder. For example, if genome-wide information is taken for a patient and present in the diagnostic information in the patient record, many potential proprietary SNPs or other biomarkers can potentially be present in the acquired diagnostic information. However, it would be impractical under most scenarios to require payment for all the proprietary SNPs that may be present in an individual patient's genome as determined through genome-wide diagnostic information. Further, the intellectual property of rights holders may only extend to certain uses of particular proprietary SNPs rather than only detection during a diagnostic test. Further, intellectual property rights may only extend to multiple biomarkers and/or clinical parameters present in one patient for the indication of risk for a specific disease or condition.

As such, a physician user can access the diagnostic information in a patient record by querying the system 700 with at least one search criterion. The search criterion can be specific biomarkers and/or a search for biomarkers that are correlated with specific diseases or conditions. Search algorithms and methods to parse through genetic information are known. Other biomarker data, such as lipidomic and proteomic data can also be searched in response to a query.

The proprietary records database 710, in addition the identity of specific biomarkers, can contain information regarding specific diseases or conditions associated with certain biomarkers. Often, these specific diseases or conditions are specified in the patent or other intellectual property grant upon which the associated rights holder relies upon. Specific diseases or conditions can be assigned unique codes for use within the system 700 to avoid the uncertainty of key word searching.

By means of a non-limiting example, a physician can request a whole or partial genome evaluation of a patient, where the generated diagnostic information is loaded into the patient record in the patient records database 705. The physician can then submit a query to the system 700 through the physician user interface 715 to search for SNPs associated with the risk for heart disease. In certain embodiments, the trusted server 701 or another processor can iteratively search the genetic information contained in the diagnostic information for proprietary biomarker SNPs and/or other SNPs associated with heart disease. Known search engines and parser algorithms such as BLAST, BioJava (http://www.biojava.org/wiki/MainPage) or BioParser (http://bioinformatics.tgen.org/brunit/software/bioparser/) can be used to search the diagnostic information for relevant proprietary biomarkers. A sub-database table or results record can be populated in the relevant patient record of the patient records database 705 with the information extracted using the parser algorithm, which will eliminate the need to parse the raw diagnostic data only one time to extract biomarkers relevant to the query.

Upon the identification of proprietary biomarkers in response to a physician query, the intellectual property of one or more rights holders can be thereby used and the process to transfer, to account for or to escrow a payment to the rights holders can then be initiated. The trusted server 701 updates a payment log or database 750 to credit an appropriate rights holder user with a monetary amount for use of proprietary biomarkers upon a successful query by a physician user that returns proprietary biomarkers in response to the query. A payment facility 760 can be present to process payments from a payer party user to a rights holder user. Payment can be automatic or only after authorization by a payer party user using the payer party user interface 730. In certain embodiments, the system 700 does not complete an actual transfer of funds between bank accounts. Rather, payment is completed for the purposes of the invention and the attached Claims when a balance in a payment log or database 750 is updated reflecting the obligation of a payer party user to remit funds. Funds can be remitted by payer parties to an Administrator of the system 700 or another party in escrow on a periodic basis, at which time the Administrator can send funds to the appropriate rights holders, and the remittance of the payment noted in the log or database 750. In other embodiments, the payment facility 760 can be programmed with the banking information of the relevant users and periodically initiate payment between the payer party users and the rights holder users using the automated clearing house (ACH) or other electronic means in a manner that ensures the anonymity of the rights holder user and the payer party user. Funds may be first transferred through a bank account set-up for the administration of the system to protect the identity of the payer party, which may in turn reveal patient identification information.

If one or more rights holder users own rights to the returned proprietary biomarker information from the query in the results record, an agreed upon calculation can be used to divide payment from a payer party user automatically between the rights holders of the proprietary biomarker information using the system 700. For example, a first rights holder user can own patent claims for a first SNP biomarker to indicate heart disease risk, and a second rights holder user can own patent claims for a second SNP biomarker to indicate heart disease risk. The system 700 and the payment facility 760 can automatically and simultaneously inform both the first and second rights holder users of the found biomarkers in one patient, and then a pre-arranged calculation can be performed to apportion payments to each rights holder user. In this manner, individual patient costs can be distributed across all patients using the system 700 whereby using the systems and methods of the invention, the rights holder users are blinded to specific patient identification information.

An additional feature of the system 700 is that the use of proprietary biomarkers can be attributed to a specific patient. That is, the patient record can be annotated to indicate, for example by means of the results record, that the use of particular biomarkers have been accessed and paid for in the past. In certain embodiments, a patient can go to another physician to get a second opinion and/or the same or a different diagnostic test can be performed that implicates biomarkers for which payment has already been made in the past. The patient can be granted a limited license to allow for the future use of a proprietary biomarker accessed in the past. As such, the patient can get a second physician's opinion and/or an additional diagnostic test without additional payment.

For example, a patient record can be updated to indicate proprietary biomarkers that have been accessed in the past and payment previously made. If a future query is made that generates a results record containing a previously accessed biomarker, the system can be set to allow further usage of that proprietary biomarker without additional payment. In certain embodiments, the length of time for which future use can be made of a previously accessed proprietary biomarker can be limited to a set period of time. The patient record can be annotated to indicate a date that a biomarker was first accessed to allow the calculation of the expiration a license for future use, where the amount of time rights to use of a biomarker can be indicated in the proprietary records database 710.

The system can also correlate a patient's demographic and physiological information with information in the system and/or accessed from one or more public or private domain databases, such as a SNP consortium, and generating a result set that includes a suggestion for genetic, proteomic, and/or other type of diagnostic testing. In a further embodiment, the present invention also relates to displaying the identified correlation to aid in determining the statistical significance of the identified correlation. In addition, the patient's diagnostic, clinical and physiological information may be compared with other patient records in the database to determine whether common attributes are present in the population identified by the system of the invention as sharing common biomarkers for use in diagnosis and treatment. Information can then be communicated to the physician indicating that the individual shares attributes with a population of individuals having a common biomarker. Such information can be included with the results record generated the physician's query.

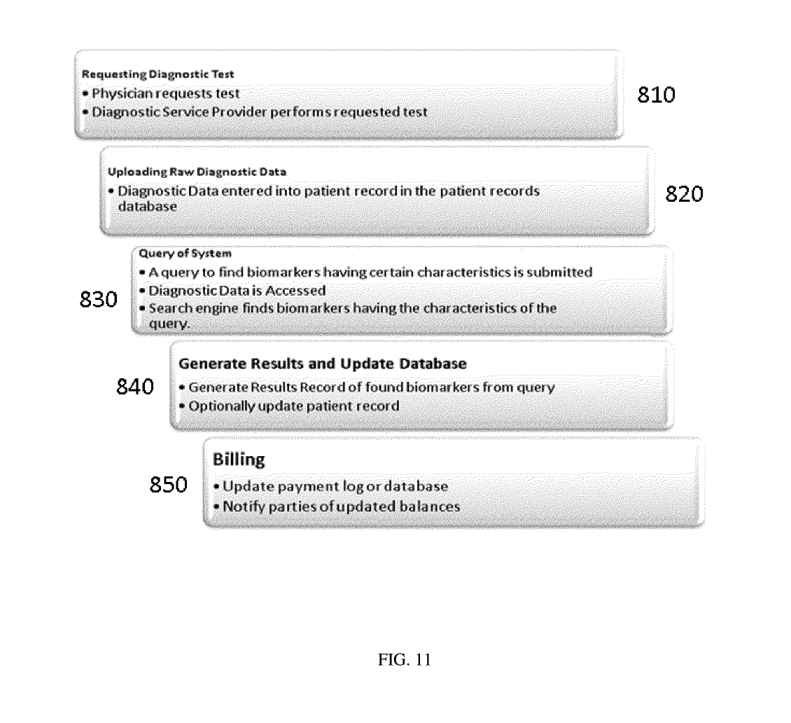

With reference to FIG. 11, an exemplary process to query the system 700 for proprietary biomarkers and remit payment to a rights holder user in a blinded fashion will be described. In step 810, a physician requests a certain diagnostic test be performed, where the raw diagnostic data generated by the diagnostic test can include proprietary biomarkers. In step 820, the raw diagnostic data is uploaded to the system 700 for addition to a specific patient record in the patient records database 705. The raw diagnostic data can be uploaded by a diagnostic service provider and the patient record identified by a reference number that maintains the anonymity of the patient.

In step 830, a physician queries the system to look for particular biomarkers in the raw diagnostic data and/or to look for biomarkers predictive or indicative for risk for specific diseases or conditions. The patient's record database is accessed by the system 700 and the raw diagnostic data is parsed to identify proprietary biomarkers having characteristics conforming to the query. In step 840, a results record is generated containing biomarkers returned by the query and optionally the physician and/or a payer party user having responsibility for the patient or rights holder user associated with the propriety biomarkers are notified. The patient record can be updated with the contents of the results record or the query. In step 850, a payment log or database is updated to reflect the need for a payment between a payer party user and a rights holder user in a blinded fashion.

### Database Structure

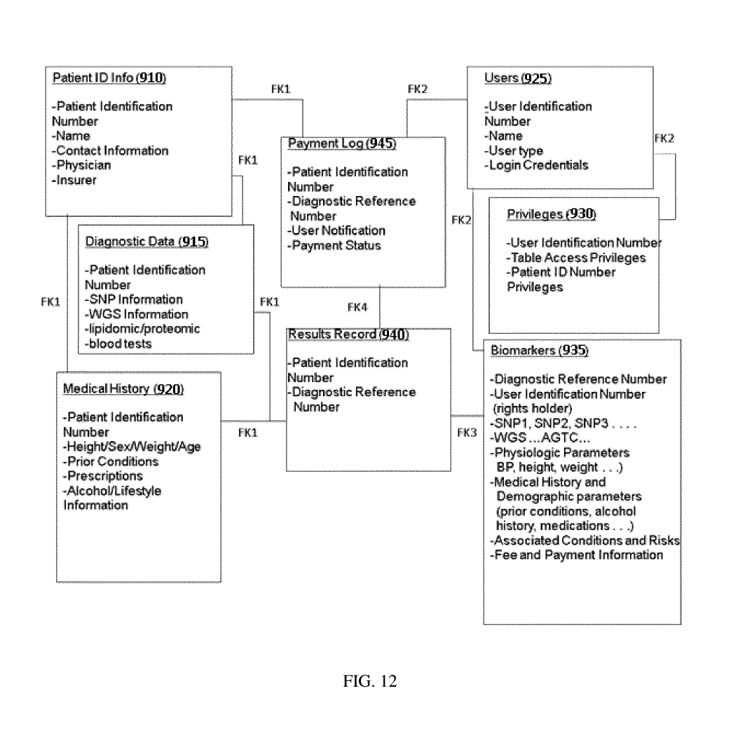

FIG. 12 shows a non-limiting example of a database structure that can be employed in conjunction with the methods and systems described herein. Those skilled in the art will readily recognize that other database structures and organizations can be equally employed to practice the methods and systems described here. FIG. 12 illustrates a structure for a relational database that can be accessed and search queries obtained through the use of structured query language (SQL).

FIG. 12 shows a relational database having several Tables having rows and columns related to the category stated in the header. As presented in tables 910-945 in FIG. 12, exemplary attributes for each table are listed. The first attribute in each of tables 910-945 can be used as a key to relate information in that table to another related table using SQL. More specifically, the first attribute in each table can serve as a candidate key that is not duplicated within any one table. The organization of tables 910-945 will now be described.

Table 910 contains patient identification information. The attributes can include a patient identification number, the patient's name, contact information, physician name and/or physician user identification number, and insurer information and/or payer user identification number. Those skilled in the art will readily recognized that other attributes may be contained in patient identification table 910. As described, protection of the information contained in the patient identification information table 910 is strictly controlled in order to protect patient privacy. As such, sensitive information regarding patient identity can be segregated on table 910 to prevent unauthorized disclosure of such information.

Data and information associated with specific patients that may have less strict control over access can be stored on tables separate from table 910. As shown in FIG. 12, a diagnostic data table 915 can be provided. In addition to containing the patient identification number attribute, table 915 can contain additional attributes related to various diagnostic tests performed on the patient associated with a patient identification number. Examples of attributes that can be provided on the diagnostic data table 915 include the presence of specific SNPs, WGS, WES, or targeted gene information, proteomic and/or lipidomic information, and results of blood tests reflecting blood chemistry. Similarly, table 920 can contain information regarding a specific patient's medical history. In addition to containing the patient identification number attribute, table 920 can contain additional attributes such as previous diagnoses, current prescriptions, height, weight, age, and other attributes typically contained in medical records. Specific attributes of tables 915 and 920 may be represented by a reference numeral rather than a word string to facilitate querying of the system.

Tables 915 and 920 can be constrained through the use of a foreign key, shown as FK1 in FIG. 12. The foreign key FK1 can be used to insure that a patient identification number attribute on tables 915 and 920 occurs and has a valid entry on patient identification information table 910. The foreign key FK1 can also be used as a constraint to ensure that a patient identification number contained on other tables, as shown in FIG. 12, occurs on tables sharing a relationship. For example, the foreign FK1 can constrain the system or any user from entering information on diagnostic data table 915 with a patient identification number that does not appear as an attribute on patient identification information table 910.

As described, the systems described herein provide for various user interfaces for interacting with the system including entering information in the system and submitting a query. User table 925 can have attributes including user identification number, user name, user type, and login credentials. The user type (e.g. physician user, rights holder user, etc.) can be used by the system to present the appropriate user interface to a user logging onto the system. The user table 925 can be related to a privileges table 930 that defines the access rights within the privacy rules operating on the system including which patient identification numbers certain users have privileges and concerning access to patient identification table 910. Foreign key F2 can be implemented to constrain privilege table 930 to only contain user identification number attributes that appear in user table 925.

Biomarkers table 935 can be further related to user table 920. Biomarkers table 935 contains the combination of biomarkers and other information that represent the intellectual property owned by specific rights holder users. In general, the user identification number attributes on table 935 are associated with rights holder users. A diagnostic reference number can be provided as an attribute that represents discrete diagnostic tests that represent an intellectual property right held by a rights holder user.

For example, a certain combination of biomarkers can represent an increased risk for cancer. By means of illustration, a rights holder can be the holder of a patent claim that recites that the presences of a G nucleotide at SNP1, and a C nucleotide at SNP2, and a weight above 200 pounds for males represents an elevated risk for certain kinds of cancers, where SNP1 and SNP2 represent specific genomic loci in the genome. The biomarkers SNP1 and SNP2 and the clinical parameters regarding weight and sex can be organized in the same row of biomarkers table 935 associated with a unique diagnostic reference number attribute. FIG. 12 shows non-limiting examples of biomarkers including SNPs, WGS, proteomic and/or lipidomic information, physiological parameters, and demographic parameters that can be associated with specific intellectual property rights. The rows of table 935 can also contain fee information associated with the use of the diagnostic test represented by that row of the table 935.

As described above, the system can be queried to identify patients having specific biomarkers or combinations of biomarkers and/or clinical parameters that represent an elevated risk or decreased risk for certain diseases and conditions. The search engine associated with the system can search for the concurrence between the specific intellectual property rights stored in biomarkers table 935 with the information stored on the diagnostic data table 915 and the medical history table 920. As described, the system, for example, can be queried to determine if a specific patient has any biomarkers and/or clinical parameters associated with an increased risk for cancer. The system will then systematically search the appearance of any combination of biomarkers and/or clinical parameters associated with a diagnostic reference number annotated to be correlated with a risk for cancer against the information stored in diagnostic data table 915 and/or medical history table 920.

Any matches from a query can be recorded in results record table 940 as shown in FIG. 12. The results record table 940 can list the patient identification number for the patient having at least one match to a diagnostic reference number. A foreign key FK3 can be employed to constrain results record table 940 to contain only diagnostic reference numbers that appear on biomarkers table 935. A payment log table 945 can be provided to record activity of the payment facility 760. The payment log table 945 can contain the patient identification numbers and diagnostic reference numbers representing a match from a query as in results record table 940. A foreign key FK4 can be provided to constrain payment log table 945 to only contain entries for combinations of patient identification number attributes and diagnostic reference number attributes that occur in results records table 940. The payment log 945 can contain further attributes concerning the status of notification to users regarding payments and the status of any pending payments between any users of the system.

### Hardware

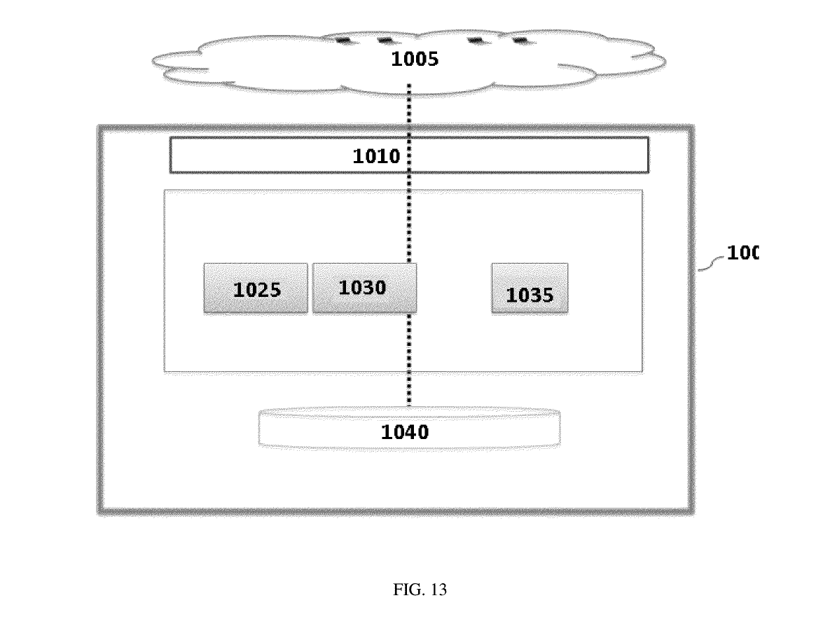

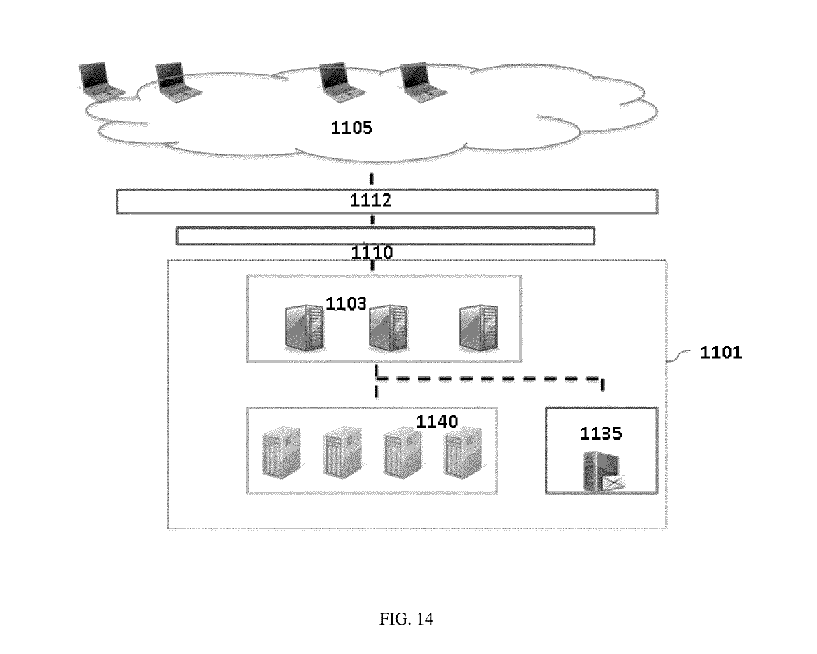

FIG. 9 illustrates the functionality of the systems and methods disclosed herein. The above-described functionality can be implemented on any hardware system adaptable to carrying out the above described functions. However, non-limiting examples of hardware systems to carry out the invention are presented in FIGS. 13 and 14.

FIG. 13 shows a hardware implementation that can be deployed on a single server 1001, where the single server can be laptop or desktop computer. The server 1001 serves as the trusted server 1001 described in FIG. 9. Users 1005 of the server 1001 can communicate with the server 1001. Communication can be accomplished via the internet or by other network means; an internet connection is not required to practice the invention. In certain embodiments, users 1005 can communicate with the server 1001 using widely-available HTML viewers.

Users 1005 first communicate with a security module 1010 implemented on the server 1001. The security module 1010 can be a form-based authentication where users are verified using a username and password combination. A username and password combination will identify the user 1010 as a physician user, diagnostic test provider, patient user, payer party user or rights holder user and implement the proper interface and related privacy rules to control access to information. Alternatively, access to the server 1001 can be granted based upon the user uploading a security file containing encrypted identification information.

The server 1001 implements a web server that includes a user interface (UI) 1025 that is presented to the user 1005. The UI 1025 is not limited to any particular software, standard or language. In certain embodiments, the UI 1025 can be based on a JavaScript Library including HTML5, css3.0 and a robust JavaScript Library Toolkit that supports Web 2.0 standards. The UI 1025 can therefore be a graphical interface that can be intuitively operated by the user 1005. As described, one or more parser algorithm tools or search engines 1030 can be implemented on the server 1001 to parse genetic data. In one embodiment, the parser algorithm tool 1030 can be BioJava (http://www.biojava.org/wiki/MainPage), which has the advantage of being readily implemented with a JAVA-based web server. In another embodiment, the parser algorithm tool 1030 can be BioParser (http://bioinformatics.tgen.org/brunit/software/bioparser). Since BioParser is written in PERL, a wrapper is required to implement BioParser with a JAVA-based web server, for example, JPL or JNI. The notification server 740, described in FIG. 9, can be implemented with an included JAVA mail client 1035 to send notifications to users 1005 even when a user 1005 is not logged onto the server 1001. The mail client 1035 can also implement the payment facility 760 where a payer party user and/or rights holder user can be notified of the obligation for a payment to be made in a blinded fashion.

The patient records database 705, the proprietary records database 710 and the payment log or database 750 can be accommodated on a storage device 1040. The databases stored on storage device 1040 are not limited to any particular structure. In some embodiments, the patient records database 705, proprietary records database 710 and the payment log or database 750 are structured to be assessable and/or queryable using structured query language (SQL) used to maintain relational databases. In one embodiment, the databases use a relational database management system such as the Oracle 8i™ product (version 8.1.7) by Oracle. In another embodiment of the databases, object-oriented database management system architecture is used.

FIG. 14 shows a hardware implementation that employs several processors for a large-scale implementation. The function of the one or more processors 703 described in FIG. 9 is carried out by one or more processing units 1103 that provide the computational power to implement a UI, a parser algorithm and a security module 1110 and provide services to users 1105 in the same manner as described above in FIG. 13. A load balancer 1112 is also present to manage work flow in implementations where more than on processing unit 1101 is present. The load balancer 1112 divides the workload multiple processing units 1101. If a fault occurs with one of the processing units 1101, the load balancer 1112 can automatically route requests from users 1105 until the fault has been corrected.

The processing units 1101 can access a storage area network (SAN) that houses the patient records database 705, the proprietary records database 710 and the payment log or database 750. A separate mail server 1135 containing dedicated processor capability can be present to generate a large volume of outgoing email. The payment facility 760 can be implemented using the one or more processing units 1103.

The software implementing the above processes can be coded in any language known in the art. This includes, but is not limited to, ASP, APS.NET, Java, JavaScript, C, C++, C#, C#.NET, Objective C, F#, F#.NET, Basic, Visual Basic, VB.NET, Go, Python, Perl, Hack, PHP, Erlang, XHP, Scala, Ruby, J2EE, SQL, CGI, HTTP, or XML.

It will be apparent to one skilled in the art that various combinations and/or modifications and variations can be made in the system depending upon the specific needs for operation. Moreover features illustrated or described as being part of one embodiment may be used on another embodiment to yield a still further embodiment.

We claim:

1. A method, comprising:
obtaining electronic representations of genetic sequences from a first set of multiple subjects;
obtaining phenotypic information from each of the subjects, wherein the phenotypic information for each subject is associated with the genetic sequence from each subject;
determining the presence or absence of one or more features in each genetic sequence;
for each feature, applying a machine learning algorithm to determine the probability that each feature is associated with a phenotypic result;
obtaining one or more features that are at least partially indicative of the phenotypic result.

2. The method of claim 1, wherein the electronic representations of the genetic sequences are raw electronic representations of the genetic sequences, and wherein the method comprises electronically converting the raw electronic representations of the genetic sequences into binary genetic sequence files.

3. The method of claim 2, wherein the raw electronic representations of the genetic sequences are in the form of FASTQ files, and wherein the binary genetic sequence files are in the form of BAM files.

4. The method of claim 1, wherein the one or more features are selected based on a supervised dimensionality reduction.

5. The method of claim 1, further comprising:
obtaining electronic representations of genetic sequences from a second set of multiple subjects and obtaining phenotypic information for each subject in the second set of multiple subjects;
determining the presence or absence of the one or more features that are at least partially indicative of the phenotypic result in the sequences of each of the second set of multiple subjects;
obtaining a probability that a phenotypic result will be present in each subject based on the presence or absence of the one or more features;
determining the accuracy of the probability that each feature is associated with a phenotypic result;
obtaining at least one feature that accurate predicts a phenotypic result.

6. The method of claim 5, further comprising obtaining electronic representations of genetic sequences for one or more subjects in a third set of subjects; and
determining the probability of the phenotypic result based on the presence or absence of the one or more features.

7. The method of claim 5, further comprising:
receiving a prescription for a genetic test on a subject, wherein the genetic test is to determine the probability or presence of the phenotypic result; and
determining the probability or presence of the phenotypic result based on a genetic sequence for the subject and the presence or absence of the one or more features.

8. The method of claim 7, wherein at least one feature is a proprietary biomarker.

9. The method of claim 8, further comprising accounting for a payment to a rights holder in the proprietary biomarker based on the use the proprietary biomarker.

10. The method of claim 1, wherein the number of subjects in the first set of subjects is between 1,000 and 5,000.

11. The method of claim 5, wherein the number of subjects in the second set of subjects is between 100 and 5,000.

12. A system comprising:
a) a genetic sequence database; wherein the genetic sequence database is configured to contain genetic sequence data and phenotypic information from multiple subjects and wherein the genetic sequence data and phenotypic information for each subject are associated;
b) a control application; wherein the control application is in communication with the genetic sequence database; and wherein the control application is configured to determine the presence or absence of one or more features in the genetic sequence data from each subject;
c) a feature matrix database in communication with the control application, wherein the control application is configured to populate the feature matrix database with the presence or absence of the one or more features for each subject and the presence or absence of a phenotypic result for reach subject; and
d) a learning program, wherein the learning program is configured to determine a probability that the phenotypic result is associated with each of the one or more features.

13. The system of claim 12, further comprising a confirmation application; wherein the testing application is configured to determine the presence of the one or more features in genetic data from one or more subjects and to determine the presence of the phenotypic result in the phenotypic information for the one or more subjects; and wherein the testing application is configured to determine whether the determined probability that the phenotypic result will be present in the phenotypic information of each subject is within a predetermined range of an actual occurrence of the phenotypic result.

14. The system of claim 13, further comprising a sequence application; wherein the sequence application is configure to obtain electronic representations of the genetic sequence data for each subject and to populate the genetic sequence database.

15. The system of claim 14, wherein the sequence application is configured to obtain raw genetic sequence data; wherein the sequence application is further configured to convert the raw genetic sequence information into a binary sequence file; and wherein the binary sequence file is used to populate the genetic sequence database.

16. The system of claim 15, wherein the raw genetic sequence data is in the form of a FASTQ file.

17. The system of claim 15, wherein the binary sequence file is in the form of a BAM file.

18. The system of claim 13, further comprising:
a) a remote application configured to receive a prescription for conducting a genetic test on a subject; and
b) a genetic test application in communication with the genetic sequence database; wherein the genetic test application is configured to determine the presence or absence of the one or more features associated with a phenotypic result in the genetic sequence information for the subject, and to determine the probability of the phenotypic result based on the presence or absence of the one or more features.

19. The system of claim 18, further comprising a proprietary records database, wherein the proprietary records database contains records of proprietary biomarkers and the rights holders of proprietary biomarkers; and wherein the system is configured to determine if the one or more features are present in the proprietary records database.

20. The system of claim 19, further comprising a payment application, wherein, for each of the one or more features present in the proprietary records database, the payment application accounts for a payment from a payer party to a rights holder party based on the prescription.
